(19) United States
(12) Patent Application Publication
(10) Pub. No.: US 2026/0116097 A1
(43) Pub. Date: Apr. 30, 2026

(54) IMAGE FORMING APPARATUS

(71) Applicant: CANON KABUSHIKI KAISHA, Tokyo (JP)

(72) Inventor: SHOTA TAKAYAMA, Chiba (JP)

(21) Appl. No.: 19/371,861

(22) Filed: Oct. 28, 2025

(30) Foreign Application Priority Data
Oct. 31, 2024 (JP) 2024-192528

(51) Int. Cl. B41J 11/00; B41J 11/06; B41J 13/08

(52) U.S. Cl. CPC B41J 11/0085; B41J 11/06; B41J 13/08

(57) ABSTRACT

An image forming apparatus includes a rotatable endless belt, a recording head, a platen portion, a suction box for holding the platen portion and for sucking the belt to the platen portion by negative pressure generated inside the suction box and suck the sheet onto the belt through the plurality of holes, a negative pressure generating portion, and an extension member which is provided detachably mountable to the suction box, which is disposed outside the platen portion with respect to a widthwise direction thereof perpendicular to a conveying direction of the belt, which is extended along a movement direction of the belt, which includes a sliding surface slidable with the inner peripheral surface of the belt, and which is configured so that an end portion of the belt closely contacts the sliding surface.

### BACKGROUND

### Field of the Technology

The present disclosure relates to an image forming apparatus, such as a printing machine, a copying machine, or a printer, for performing image formation by utilizing an ink jet type.

### Description of the Related Art

In recent years, also, in the field of commercial printing and industrial printing in which analog printing such as offset printing goes mainstream, there is an increasing need for ink jet printing as digital printing capable of printing of designs in small amount and many kinds. The ink jet type has many advantages that a printing plate is not required and that a high-quality product can be obtained, and the like, and therefore, spread thereof is conspicuous. The image forming apparatus of the ink jet type (ink jet recording apparatus) ejects ink droplets on a recording medium such as recording paper or a resin sheet and records an image such as a character. As the image forming apparatus of the ink jet type, there is an ink jet recording apparatus of a line head type. In this recording apparatus, in a state in which a recording head is not moved relative to an image forming apparatus main assembly, in association with conveyance of the recording medium, liquid droplets of different colors are ejected from a plurality of recording heads, so that a color image is recorded on the recording medium. Further, as the ink jet recording apparatus of the line head, a recording apparatus in which conveyance of the recording medium relative to the recording heads is performed by using a print belt constituted by an endless belt has been known. The print belt is stretched by a plurality of stretching rollers, and the recording medium is attracted to a conveying surface which is a surface formed between the stretching rollers on sides upstream and downstream of the recording heads and is conveyed.

In such an image forming apparatus, in order to obtain a high-quality product, a distance between the recording medium and the recording head (specifically, minute nozzles ejecting ink of the recording head) is important. For that reason, a type in which a cut recording medium is conveyed along a flat surface (printing flat surface) high in flatness has been known. As one example of such a type, there is a method in which the recording medium is conveyed while being sucked to a conveying surface of a print belt (Japanese Laid-Open Patent Application No. 2016-140997). That is, the print belt is provided with minute holes, and in addition, the print belt is slidably supported by a platen member constituted so as to have an opening. Then, air is sucked from an inner peripheral surface side of the print belt, so that the print belt is attracted to the platen member, and in addition, the recording medium is conveyed by the print belt while being attracted to the print belt.

### SUMMARY

The present disclosure is directed to suppress a lowering in sealing property of a suction box.

This is achieved by an image forming apparatus according to the present disclosure.

According to an aspect of the present disclosure, there is provided an image forming apparatus comprising: a rotatable endless belt provided with a plurality of holes and configured to carry and convey a sheet; a recording head provided opposed to the belt and configured to eject a liquid for recording to the sheet conveyed by the belt; a platen portion configured to slidably support an inner peripheral surface of the belt in a position opposing the recording head through the belt and configured to form a conveying surface on which the sheet is conveyed; a suction box configured to hold the platen portion and configured to suck the belt to the platen portion by negative pressure generated inside the suction box and suck the sheet onto the belt through the plurality of holes; a negative pressure generating portion configured to generate the negative pressure in the suction box; and an extension member which is provided detachably mountable to the suction box, which is disposed outside the platen portion with respect to a widthwise direction thereof perpendicular to a conveying direction of the belt, which is extended along a movement direction of the belt, which includes a sliding surface slidable with the inner peripheral surface of the belt, and which is configured so that an end portion of the belt closely contacts the sliding surface.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of the image forming apparatus.

FIG. 2 is a schematic sectional view of a print module.

FIG. 3 is a schematic sectional view of a constitution of a part of a print belt unit.

FIG. 4 is a perspective view of a recording head.

Parts (a) and (b) of FIG. 5 are front views showing a recording head supporting constitution.

Parts (a) and (b) of FIG. 6 are front views showing a recording head supporting constitution.

FIG. 7 is a perspective view showing a recording head supporting constitution.

FIG. 8 is a perspective view showing a unit frame and a platen supporting member of a suction box.

FIG. 9 is a perspective view of a platen supporting member.

FIG. 10 is a perspective view of a suction box.

FIG. 11 is a perspective view of a print belt unit provided with a suction box and a suction device.

FIG. 12 is a perspective view of the suction device.

FIG. 13 is a perspective view of a sealing member.

FIG. 14A is a perspective view for illustrating a mounting constitution of the sealing member.

FIG. 14B is a perspective view for illustrating a mounting constitution of the sealing member.

FIG. 15 is a perspective view of an exchange unit provided with a platen member and the sealing member.

### DESCRIPTION OF THE EMBODIMENTS

In the following, an image forming apparatus according to the present disclosure will be described further specifically with reference to the drawings.

### Embodiment 1

### Image forming apparatus

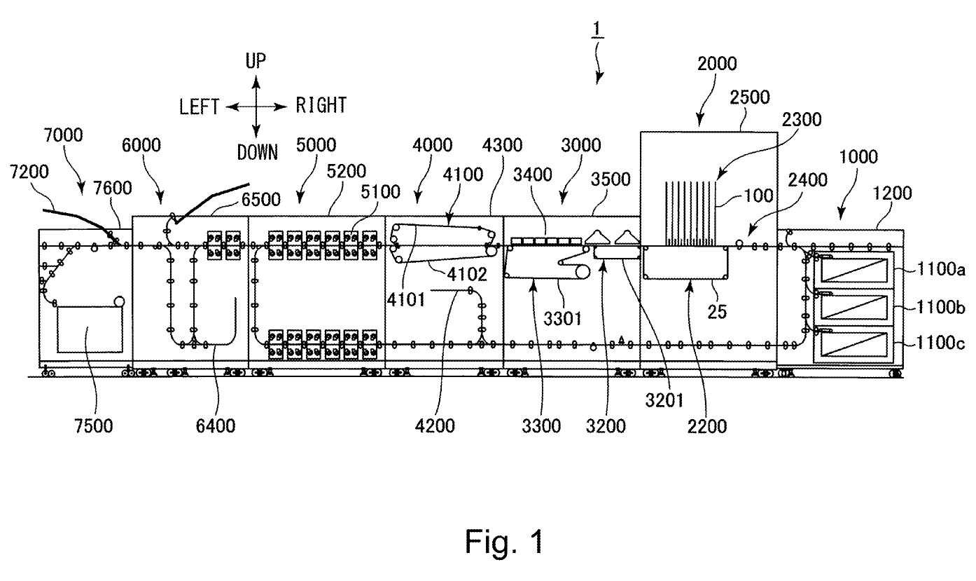

First, a general constitution of an image forming apparatus according to this embodiment will be described. The image forming apparatus of this embodiment is an ink jet recording apparatus 1 of a line head type utilizing an ink jet type. FIG. 1 is a schematic sectional view showing a general constitution of the ink jet recording apparatus 1 of this embodiment. This ink jet recording apparatus 1 is a sheet type ink jet recording apparatus in which an ink image is formed on a sheet S such as out plain paper, which is a recording medium (recording material, sheet) by using two liquids, as liquids for recording, consisting of a reaction liquid and ink and then a recording product is outputted.

Incidentally, in the following description, the ink jet recording apparatus 1 is assumed to be installed on a horizontal surface. Further, as regards the ink jet recording apparatus 1 and elements thereof, on the drawing sheet of FIG. 1, a front side is referred to as a "front (front surface)" side, a rear side is referred to as a "rear (rear surface)" side, a right side is referred to as a "right" side, a left side is referred to as a "left" side, an upper side is referred to as an "upper (UP)" side, and a lower side is referred to as a "lower (DOWN)" side. A front-rear direction is perpendicular to a left-right direction and an up-down direction. In the case where the ink jet recording apparatus 1 is installed on the horizontal surface, the up-down direction is parallel to a gravitational direction (vertical direction). However, as regards the ink jet recording apparatus 1 and the elements thereof, the "up" and the "down" do not mean only "immediately above", and "immediately below", respectively, and include an "upper side" and a "lower side", respectively, with respect to a horizontal surface passing through a noticed element or a noticed position.

Further, in the following description, the sheet S is referred to as paper, but the sheet S includes a material other than paper, or those (synthetic paper and film formed using synthetic resin, metalized paper having a metal layer, and the like) formed of a material containing the material other than the paper. Further, for convenience, the liquid for recording, such as the reaction liquid or the ink is simply referred to as "ink", but may also be an arbitrary liquid, such as a reaction liquid or ink, used for image recording.

The ink jet recording apparatus 1 includes modules (sheet processing portion) including a sheet (paper) feeding module 1000, a print module 2000, a drying module 3000, a fixing module 4000, a cooling module 5000, a reversing module 6000, and a sheet (paper) discharge stacking module 7000. A cut paper-like sheet S fed from the sheet feeding module 1000 is conveyed along a conveying path and processed by the respective modules, and then is guided to the sheet discharge stacking module 7000.

The sheet feeding module 1000 includes three accommodating boxes 1100a, 1100b, and 1100c for accommodating sheets S, and a casing 1200 in which these boxes are accommodated, and the like member. Each of the accommodating boxes 1100a, 1100b, and 1100c is constituted so as to be capable of being pulled out toward a front side relative to the casing 1200. The sheets S are fed from each of the accommodating boxes 1100a, 1100b, and 1100c one by one by a separation belt and conveying rollers, and the fed sheet S is conveyed toward the print module 2000. Incidentally, the number of the accommodating boxes 1100a, 1100b, and 1100c is not limited to three, but may also be one, two, or four or more.

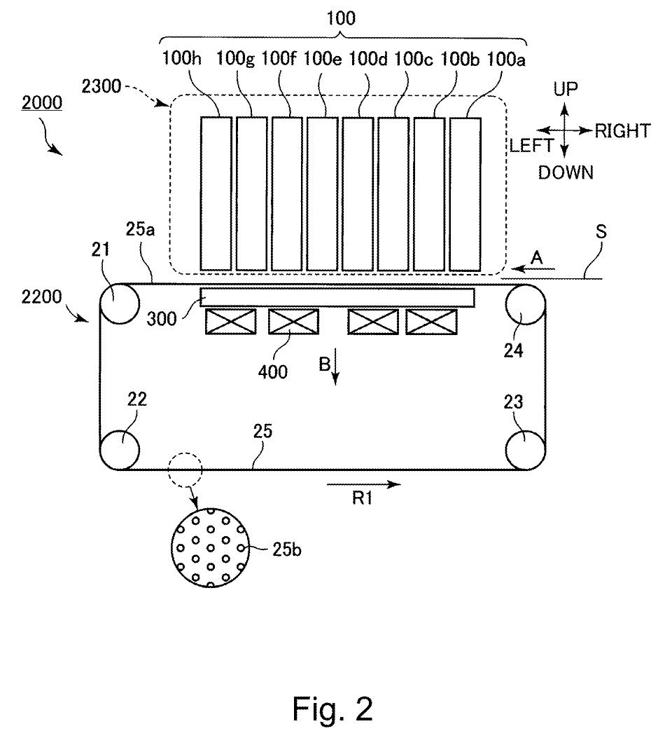

The print module 2000 includes a registration correcting portion (pre-image formation registration correcting portion) 2400, a print belt unit 2200 as a belt conveying device, a recording portion (image forming portion) 2300, a casing 2500 for accommodating therein these members, and the like. The sheet S conveyed from the sheet feeding module 1000 to the print module 2000 is corrected in inclination and position thereof by the registration correcting portion 2400 and is conveyed toward the print belt unit 2200. The recording portion 2300 is disposed in a position opposing the print belt unit 2200 while sandwiching a conveying path of the sheet S therebetween. The recording portion 2300 form an image on the sheet S by subjecting the sheet S, conveyed by the print belt unit 2200, to recording processing (image formation, printing, print) from above by a recording head 100. The sheet S is ensured to form a clearance between itself and the recording head 100 by being attracted and conveyed by a print belt 25 of the print belt unit 2200. A conveying direction of the sheet S by the print belt unit 2200 is a direction from a left side toward a right side. Further, the recording portion 2300 includes a plurality of recording heads (line type recording heads) 100 arranged along the conveying direction of the sheet S. In this embodiment, the recording portion 2300 includes eight recording heads 100 (100a to 100h), as the plurality of recording heads 100, corresponding to four colors of Y (yellow), M (magenta), C (cyan), and Bk (black), three colors which is particular colors such as white and neon color, and a reaction liquid (FIG. 2). Incidentally, the number of the colors and the number of the recording heads 100 are not limited to eight. As the ink jet type of the recording heads 100, it is possible to employ a type using heat generating elements, a type using piezoelectric elements, a type using electrostatic elements, a type using MEMS elements, and the like type. Each of the color inks is supplied from an ink tank provided to the print module 2000 to the corresponding recording head 100 through an ink tube, for example. The sheet S subjected to recording processing by the recording portion 2300 is conveyed by the print belt unit 2200 and passes through an in-line scanner (not shown) provided on a side downstream of the recording portion 2300 with respect to the conveying direction of the sheet S. The ink jet recording apparatus 1 is capable of correcting a print image on the basis of deviation and color density of the image formed on the sheet S, detected by the in-line scanner.

The drying module 3000 includes a decoupling portion 3200, a drying belt unit 3300, a warm air blowing portion 3400, a casing 3500 accommodating these members therein, and the like. The drying module 3000 reduces a liquid component contained in the ink supplied onto the sheet S in the recording portion 2300 and enhances a fixing property between the sheet S and the ink. The sheet S subjected to the recording processing by the recording portion 2300 of the print module 2000 is conveyed to the decoupling portion 3200 disposed in the drying module 3000. The decoupling portion 3200 is capable of conveying the sheet S by air pressure from above and friction of the decoupling portion 3200 with a belt 3201. In the decoupling portion 3200, the sheet S on the belt 3201 is conveyed while being weakly held, so that deviation of the sheet S, on which an ink image is formed, on the print belt 25 of the print belt unit 2200 can be prevented. The sheet S conveyed from the decoupling portion 3200 to the drying belt unit 3300 is sucked and conveyed by a belt 3301 of the drying belt unit 3300. Simultaneously therewith, hot air is supplied from the warm air blowing portion 3400 disposed above the belt 3301 of the drying belt unit 3300, so that the surface of the sheet S on which the ink is supplied is dried. Incidentally, as a drying type, it is possible to use, in addition to the type of supplying the hot air, a type irradiating the surface of the sheet S with electromagnetic radiation (such as ultraviolet radiation or infrared radiation) and a conductive heat transfer type by contact of a heat generating member. These types may be combined arbitrary.

The fixing module 4000 includes a fixing belt unit 4100 and a casing 4300 accommodating the fixing belt unit 4100. The fixing module 4000 is capable of fixing the ink on the sheet S by passing the sheet S, conveyed from the drying module 3000 to the fixing module 4000, through between an upper belt unit 4101 and a lower belt unit 4102 which are heated.

The cooling module 5000 includes a plurality of cooling portions 5100 and a casing 5200 accommodating these cooling portions 5100. The cooling module 5000 cools the sheet S conveyed from the fixing module 4000 to the cooling module 5000 and high in temperature. The cooling portion 5100 takes external air into a cooling box and increases pressure in the cooling box, and is constituted so as to cool the sheet S by blowing wind, jetted from nozzles formed on a conveying guide. The cooling portion 5100 is disposed on each of opposite sides while sandwiching a conveying path of the sheet S, and is capable of cooling the sheet S from the opposite sides. Further, in the cooling module 5000, a switching portion for switching the conveying path of the sheet S is provided. This switching portion is capable of switching the conveying path of the sheet S depending on the case where the sheet S is conveyed to the reversing module 6000 and the case where the sheet S is conveyed to a double-side conveying path used during double-side printing. During the double-side printing, the sheet S is conveyed to the double-side conveying path provided in a lower portion of the cooling module 5000 and is further conveyed along the double-side conveying path provided in lower portion of the fixing module 4000, the drying module 3000, the print module 2000, and the sheet feeding module 1000. By this, the sheet S is convey again toward the registration correcting portion 2400 of the print module 2000, the print belt unit 2200, and the recording portion 2300, and is subjected to the recording processing by the recording portion 2300. Incidentally, the double-side conveying path of the fixing module 4000 is provided with a first reversing portion 4200 for turning the sheet S upside down, and the first reversing portion 4200 is configured so as to be capable of conveying the sheet S again toward the recording portion 2300 after the sheet S is turned upside down during the double-side printing.

The reversing module 6000 includes a second reversing portion 6400, a casing 6500 accommodating this second reversing portion 6400, and the like. The reversing module 6000 is capable of turning the sheet S, conveyed from the cooling module 5000 to the reversing module 6000, upside down and is capable of freely changing front/rear surfaces (sides) of and a direction of leading/trailing ends, with respect to the conveying direction, of the sheet S to be discharged from the reversing module 6000.

The sheet discharge stacking module 7000 includes a top tray 7200, a stacking portion 7500, a casing 7600 provided with these portions 7200 and 7500, and the like. The sheet discharge stacking module 7000 is capable of aligning sheets conveyed from the reversing module 6000 to the sheet discharge stacking module 7000 and then discharging and stacking the sheets onto the top tray 7200 or stacking and accommodating the sheets S into the stacking portion 7500.

### Print module

Next, a schematic constitution of the print module 2000 in the ink jet recording apparatus 1 of this embodiment will be described.

FIG. 2 is a schematic sectional view of the print module 2000. The print module 2000 forms an image (ink image) on the sheet S by subjecting the sheet S, conveyed by the print belt unit 2200, to recording processing by the recording head 100 of the recording portion 2300 from above the sheet S. The print module 2000 is provided with the print belt unit 2200 for conveying the sheet S by sucking and attracting the sheet S so that conveying behavior of the sheet S is stabilized immediately below the recording head 100. The print belt unit 2200 includes a plurality of stretching rollers 21 to 24, the print belt 25, a suction box (vacuum box, platen unit) 300, and a suction device 400.

The print module 2000 subjects the sheet S, to the recording processing, carried out conveyed on a conveying surface (image forming surface, print surface) 25a of the print belt 25 immediately below the recording head 100 and opposing the recording head 100. On the inner peripheral surface side of the print belt 25, the suction box 300 as a belt supporting portion for slidably supporting the print belt 25 while sucking the print belt 25 is provided. The recording head 100 subjects the sheet S, to the recording processing, conveyed by being sucked and attracted to the conveying surface 25a of the print belt 25. The sheet S sucked and attracted to the conveying surface 25a of the print belt 25 is conveyed in a state in which a clearance thereof from the recording head 100 is ensured.

### Print belt unit

Next, a schematic constitution of the print belt unit 2200 in the ink jet recording apparatus 1 of this embodiment will be described. As described above, the print belt unit 2200 includes the plurality of stretching rollers 21 to 24, the print belt 25, the suction box (vacuum box, platen unit) 300, and the suction device 400.

In this embodiment, the print belt (conveying belt) 25 constituted by an endless belt is extended around, as a plurality of stretching rollers, four stretching rollers consisting of first, second, third, and fourth stretching rollers 21, 22, 23, and 24, respectively, and is stretched with predetermined tension. In this embodiment, the platen belt 25 is constituted by using PET (polyethylene terephthalate) which is a resin material. Further, in this embodiment, a size of the print belt 25 with respect to a widthwise direction (direction substantially perpendicular to a surface movement direction) is set so that a sheet S having a B3 size (364mm x 515mm) can be fed laterally (conveyed so that a short side extends in a direction along the conveying direction). Incidentally, the resin material constituting the print belt 25 is not limited to PET, but it is possible to use, for example, other resin materials such as polyimide and polycarbonate, and a metal material.

In this embodiment, the first stretching roller 21 is driving roller for rotating (circulating and moving) the print belt 25 in an arrow R1 direction (counterclockwise direction). In this embodiment, the second stretching roller 22 is a tension roller urged from the inner peripheral surface side toward an outer peripheral surface side of the print belt 25 by an urging mechanism (not shown) as an urging means and for applying a force, to the print belt 25, for stretching the print belt 25. In this embodiment, the third stretching roller 23 is a steering roller of which one end portion with respect to a rotational axis direction is movable and of which rotational axis direction is tiltable so as to be inclined relative to rotational axes of other stretching rollers. In this embodiment, the print belt unit 2200 is constituted so that a traveling position of the print belt 25 with respect to the widthwise direction (the direction substantially perpendicular to the surface movement direction) can be corrected (meandering is suppressed) by tilting of the steering roller 23. Further, in this embodiment, the fourth stretching roller 24 functions as another conveying surface forming roller for forming the conveying surface 25a between itself and the first stretching roller 21 functioning as a conveying surface forming roller.

The first stretching roller 21 is rotationally driven by a driving force transmitted from a motor which is a driving source provided in a belt driving portion (not shown) as a driving means provided in the print belt unit 2200. The second, third, and fourth stretching rollers 22, 23, and 24 are rotated with rotation of the print belt 25. The first, second, third, and fourth stretching rollers 21, 22, 23, and 24 are rotatably supported by supporting side plates (not shown) constituting the print belt unit 2200 in opposite end portions thereof with respect to the rotational axis directions thereof. The supporting side plates are mounted to a belt unit frame (not shown) which is a supporting structure constituting the print belt unit 2200. Further, in this embodiment, the first, third, and fourth stretching rollers 21, 23, and 24 are constituted by elastic rollers each including an elastic layer formed of an elastic material (urethane rubber or the like) around a core metal. Further, in this embodiment, the second stretching roller 22 is constituted by a metal roller formed of a metal material. Incidentally, the number of the stretching rollers for the print belt 25 is not limited to four, but may also be two, three or more than four.

Of surfaces of the print belt 25 formed by the first to fourth stretching rollers 21 to 24, the sheet S is carried and conveyed on the conveying surface 25a which is the outer peripheral surface of the print belt 25 stretched between the first stretching roller 21 and the fourth stretching roller 24. That is, the print belt 25 carries and conveys the sheet S on the conveying surface 25a opposing the recording head 100 immediately below the recording head 100. On the inner peripheral surface side of the print belt 25, the suction box 300 as the belt supporting portion slidably supporting the print belt 25 while sucking the print belt 25. The suction box 300 slidably supports the inner peripheral surface of the print belt 25 between the fourth stretching roller 24 and the first stretching roller 21 with respect to a rotational direction (traveling direction) of the print belt 25, i.e., an inner peripheral surface of the print belt 25 corresponding to the conveying surface 25a. Particularly, in this embodiment, the suction box 300 (specifically, a platen member 303 described later) is disposed so as to contactable to the print belt 25 at least in a range including an entire region from a position of the conveying surface 25a of the print belt 25 opposing a most upstream recording head 100a (specifically, a nozzle thereof) with respect to the movement direction (left-right direction, traveling direction) of the conveying surface 25a to a position of the conveying surface 25a opposing a most downstream recording head 100h (specifically, a nozzle thereof) with respect to the movement direction of the conveying surface 25a. Further, in this embodiment, the suction box 300 (specifically, the platen member 303 described later) is disposed so as to be contactable to the print belt 25 at least in an entire area of a region in which the print belt 25 is capable of carrying the sheet S with respect to the widthwise direction (front-rear direction). Incidentally, details of the suction box 300 and the suction device 400 will be described later.

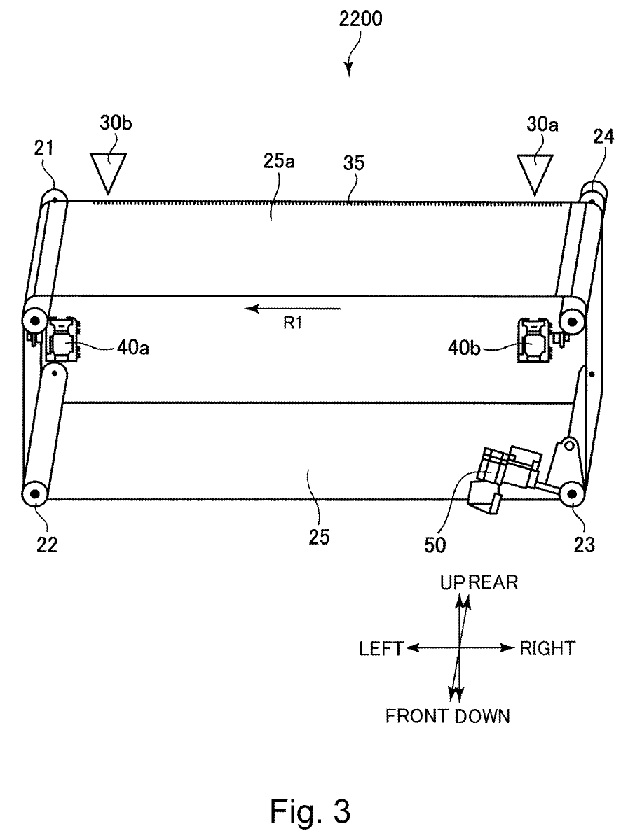

Next, control of a traveling position of the print belt 25 with respect to the widthwise direction of the print belt 25 in the ink jet recording apparatus 1 of this embodiment will be described. FIG. 3 is a schematic perspective view showing a constitution of a part of the print belt unit 2200.

In this embodiment, the first stretching roller 21 is the driving roller as described above, and is movably supported in the rotational axis direction thereof. The first stretching roller 21 is moved in the rotational axis direction by a driving force from a driving source (not shown) provided to a first moving mechanism 40a as a moving means. Further, the second stretching roller 22 is the tension roller as described above.

Further, the third stretching roller 23 is the steering roller as described above. The third stretching roller 23 is tilted by a driving force from a driving source provided to a tilting mechanism 50 as a tilting means. The fourth stretching roller 24 is movably supported with respect to the rotational axis direction. The fourth stretching roller 24 is moved in the rotational axis direction by a driving force from a driving source provided to a second moving mechanism 40b as a moving means.

In the neighborhood of each of the first and fourth stretching rollers 21 and 24, first or second belt position sensor 30a or 30b as a belt position detecting means for reading a marker 35 provided in a rear-side end portion with respect to the widthwise direction of the print belt 25 is provided. That is, the first belt position sensor 30a is disposed close to the fourth stretching roller 24 than to a center of the conveying surface 25a with respect to the movement direction of the conveying surface 25a. Further, the second belt position sensor 30b is disposed close to the first stretching roller 21 than to the center of the conveying surface 25a with respect to the movement direction of the conveying surface 25a. The sheet S is conveyed integrally with the print belt 25 by being sucked on the conveying surface 25a of the print belt 25. For this purpose, the stretching rollers movable in the rotational axis direction for adjusting the position of the print belt 25 may desirably be the first and fourth stretching rollers 21 and 24 which are two stretching rollers for forming the conveying surface 25a. The first and second belt position sensors 30a and 30b for detecting the position of the print belt 25 may desirably be provided in the neighborhoods of the fourth and first stretching rollers 24 and 21, respectively. The first stretching roller 21 is moved in the rotational axis direction thereof on the basis of a detection result of the position of the print belt 25 by the second belt position sensor 30b, and adjusts the traveling position of the print belt 25 with respect to the widthwise direction of the print belt 25. The fourth stretching roller 24 is moved in the rotational axis direction thereof on the basis of a detection result of the position of the print belt 25 by the first belt position sensor 30a, and adjusts the traveling position of the print belt 25 with respect to the widthwise direction of the print belt 25. Each of the rollers forming the conveying surface 25a of the print belt 25 adjusts the traveling position of the print belt 25 with respect to the widthwise direction, and thus is capable of positioning entirety of the conveying surface 25a with accuracy.

Detection of the position of the print belt 25 by the first and second belt position sensors 30a and 30b will be described. In this embodiment, in a rear-side end portion of the print belt 25 with respect to the widthwise direction, a plurality of circular holes each of about 1 mm in diameter in plan view are provided as the marker 35. These holes as the marker 35 are provided over one full circumferences of the print belt 25 so as to be substantially equidistantly with a center-to-central distance of 6 mm with respect to the rotational direction of the print belt 25. These holes as the marker 35 are an example of a belt position detecting shape as a belt position instruction means.

In this embodiment, the first and second belt position sensors 30a and 30b are sensors of a CIS (Contact Image Sensor) type. Each of the first and second belt position sensors 30a and 30b reads the associated hole as the marker 35 and calculates a center position of the associated hole, and a calculation result thereof is used as a detection result of the traveling a position of the print belt 25 with respect to the widthwise direction of the print belt 25. This detection result is inputted to a controller (control circuit) (not shown) for controlling an operation of the print module 2000 or the ink jet recording apparatus 1, and is used for controlling operations of the first and second moving mechanisms 40a and 40b by the controller. For example, when the positions of the print belt 25 with respect to the widthwise direction detected by the first and second belt position sensors 30a and 30b are controlled so as to be the same, the traveling position of the print belt 25 with respect to the widthwise direction can be moved (changed). Further, for example, when the positions of the print belt 25 with respect to the widthwise direction detected by the first and second belt position sensors 30a and 30b are controlled so as to become shifted positions, the conveying direction of the print belt 25 can be shifted (inclined) with respect to the left-right direction.

### Recording head

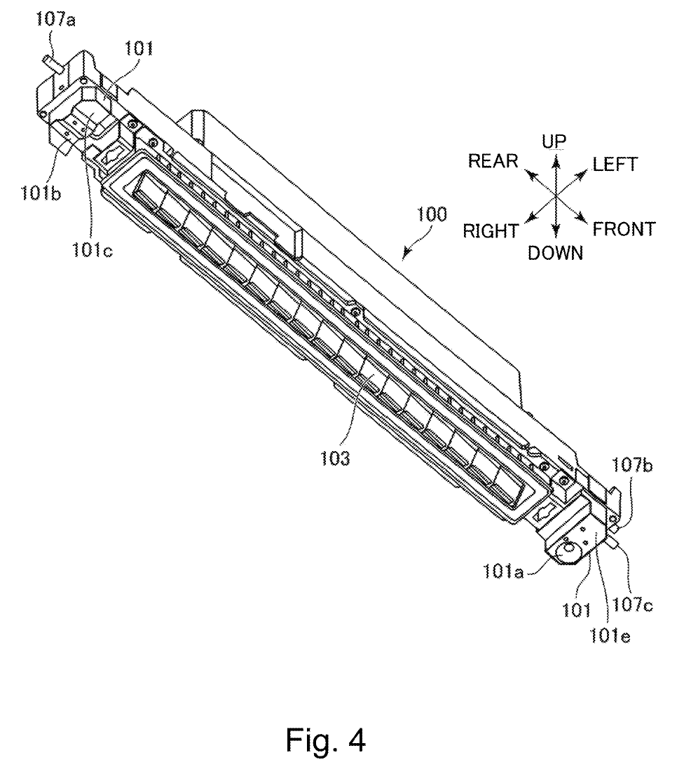

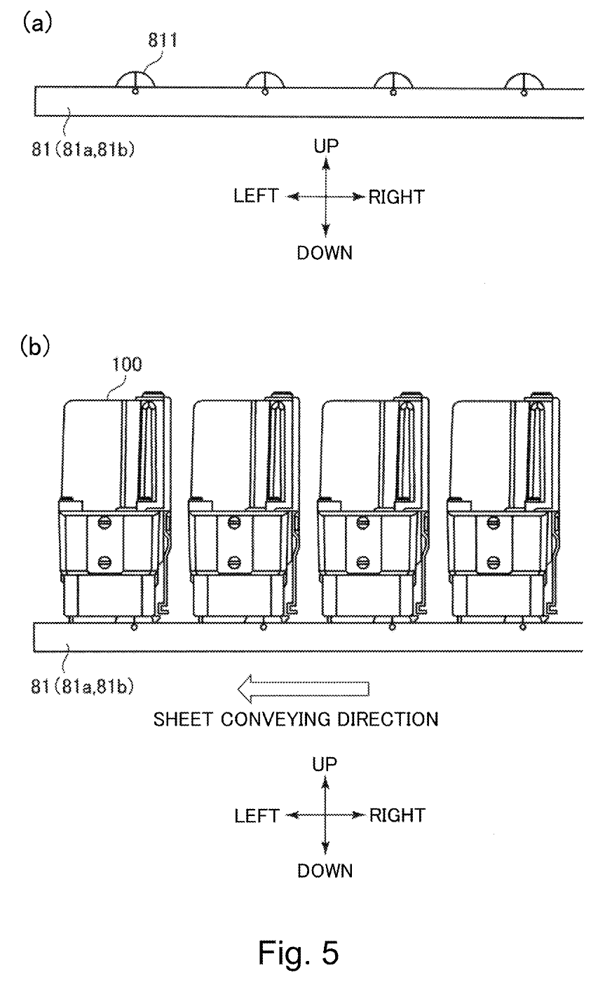

Next, the recording head 100 in the ink jet recording apparatus 1 of this embodiment will be further described. FIG. 4 is a perspective view of the recording head 100.

As shown in FIG. 4, in the recording head 100, a plurality of nozzle plates 103 provided nozzles through which ink is ejected are aligned and disposed in a longitudinal direction (front-rear direction) of the recording head 100. Further, a positioning portion 101 is provided in each of opposite end portions of the recording head 100 with respect to the longitudinal direction. Specifically, in the front-side end portion of the recording head 100, a first contact portion 101a including a recessed portion having a conical-shaped inclined surface decreased in diameter toward an upper side is provided. Further, in the rear-side end portion of the recording head 100, a second contact portion 101b including a groove portion having two V-shaped flat surfaces narrowed in width with respect to a left-side direction, toward an upper side, and a third contact portion 101c including a substantially horizontal flat surface portion are provided. The second contact portion 101b is provided in a position opposing the first contact portion 101a with respect to the front-rear direction and the third contact portion 101c is provided on a left side of the second contact portion 101b.

Further, in the rear-side end portion of the recording head 100 with respect to the longitudinal direction, a first pin 107a extending in the longitudinal direction of the recording head 100 is provided. Further, in the front-side end portion of the recording head 100 with respect to the longitudinal direction, a second pin 107b and a third pin 107c extending in the longitudinal direction of the recording head 100 are provided. The second pin 107b and the third pin 107c are aligned and disposed in an up-down (vertical) direction.

The first contact portion 101a and the second contact portion 101b are accurately disposed so that a rectilinear line connecting centers of the first contact portion 101a and the second contact portion 101b with respect to the left-right direction is parallel to an arrangement direction of the plurality of nozzle plates 103 of the recording head 100.

### Supporting constitution and the like of recording head

Next, a supporting constitution of the recording head 100 in the ink jet recording apparatus 1, an operation example of the recording head 100 toward a print position, and a positioning method of the recording head 100 will be described.

Parts (a) and (b) of FIG. 5 are front views for illustrating the supporting constitution of the recording heads 100. Part (a) of FIG. 5 shows the supporting constitution of the recording head 100 in a state in which the recording heads 100 are not disposed, and part (b) of FIG. 5 shows the supporting constitution in a state in which the recording heads 100 are disposed.

As shown in part (a) of FIG. 5, a recording head supporting portion (supporting structure portion) 81 in a belt unit frame constituting the print belt unit 2200 is provided with a positioning member 811 for positioning the plurality of recording heads 100. The recording heads 100 are positioned by being contacted to the positioning member 811. In this embodiment, the positioning member 811 is constituted by a spherical member (positioning ball). Further, in this embodiment, each of the recording heads 100 is provided with three positioning members consisting of first, second, and third positioning members as the positioning members 811a, 811b, and 811c as the positioning member 811 (parts (a) and (b) of FIG. 6). The front-side first positioning ball 811a is provided on a front-side recording head supporting portion 81a in the belt unit frame. Further, the rear-side second and third positioning balls 811b and 811c are provided on a rear-side recording head supporting portion 81b in the belt unit frame. In this embodiment, the front-side recording head supporting portion 81a is provided on a front side of the front-side end portion of the print belt 25 with respect to the front-rear direction, and the rear-side recording head supporting portion 81b is provided on a rear side of the rear-side end portion of the print belt 25 with respect to the front-rear direction. Upper surfaces of the recording head supporting portions 81a and 81b are provided with holding holes (not shown) which are holes for holding the positioning members 811a, 811b, and 811c. Positions of members 811a, 811b, and 811c with respect to the front-rear direction are fixed by being engaged in the holding holes provided in predetermined rollers. As shown in part (b) of FIG. 5, the recording head 100 retracted above from the positioning member 811 is positioned in contact with the positioning member 811 by being distended. Incidentally, the positioning member 811 is provided as a separate member from the recording head supporting portion 81 may also be held by a positioning member holder member which is mounted to the recording head supporting portion 81 and which is provided with the above-described holding holes.

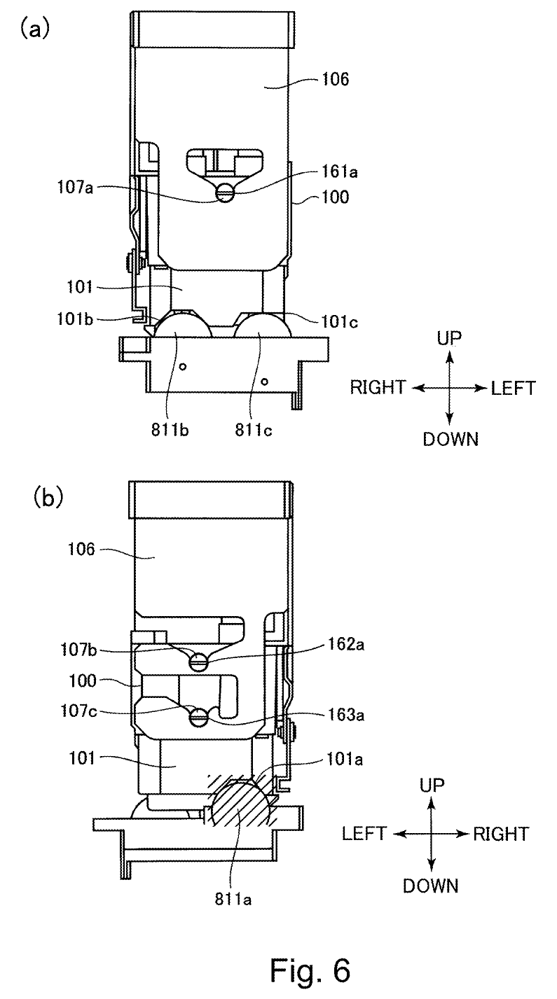

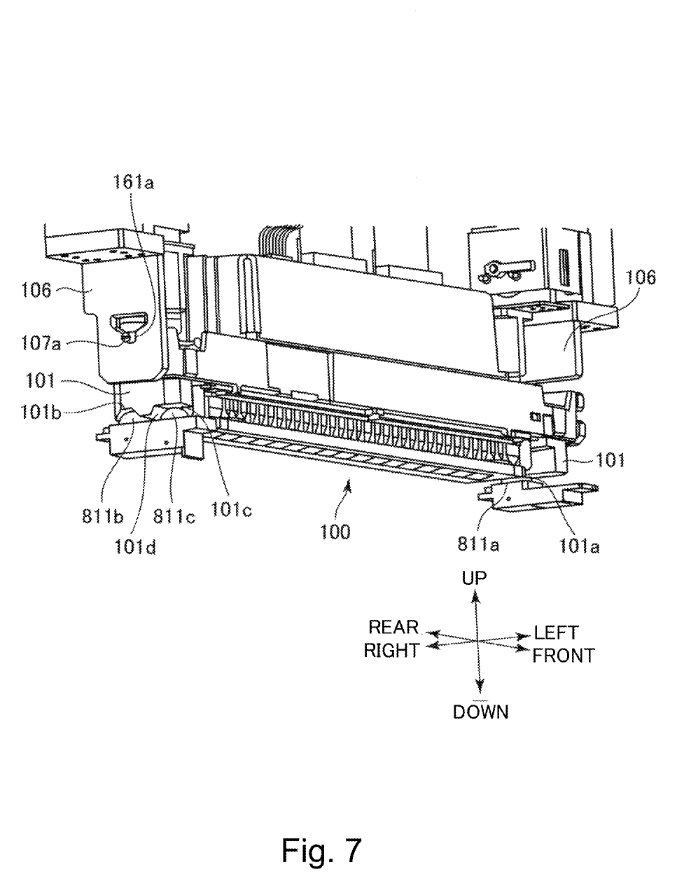

Parts (a) and (b) of FIG. 6 are front views (showing a state in which the recording head 100 is in the print position) for illustrating an operation example of the recording head 100 to the print position and a positioning method of the recording head 100. Part (a) of FIG. 6 shows a state as viewed from the rear side, and part (b) of FIG. 6 shows a state as viewed from the front side. Further, FIG. 7 is a perspective view (showing a state of the conveying surface 25a of the print belt 25 as viewed from a downstream side of the conveying direction) for illustrating the operation example of the recording head 100 to the print position and the positioning method of the recording head 100. Incidentally, the plurality of recording heads 100 are substantially the same in supporting constitution and positioning constitution, so that description will be made by paying attention to one recording head 100.

A head holder 106 holding the recording head 100 descends, so that the recording head 100 descends from a retracted position toward the print position shown in parts (a) and (b) of FIG. 6. Then, as shown in parts (a) and (b) of FIG. 6, the first contact portion 101a and the first positioning member 811a contact each other. Further, the second contact portion 101b and the second positioning member 811b contact each other.

Further, the third contact portion 101c and the third positioning member 811c contact each other. At this time, the first pin 107a, the second pin 107b, and the third pin 107c of the recording head 100 are maintained in a state of being supported by a first groove portion 161a, a second groove portion 162a, and a third groove portion 163a, respectively, of the head holder 106. When the head holder 106 descends from the retracted position toward the print position, there is need to move the plurality of recording heads 100 to a predetermined height. For that reason, a head position sensor (not shown) as a head position detecting means is provided in a detecting position between the retracted position and the print position between which the recording head 100 descends from the retracted position toward the print position. By this head position sensor, detection of positions of the plurality of recording heads 100 is performed. From the positions (detected positions) where the positions of the plurality of recording heads 100 are detected, the plurality of recording heads 100 are descended only by a predetermined penetration amount, respectively. In this embodiment, the print module 2000 is capable of controlling a driving amount of a motor as a driving source provided to an ascending/descending mechanism (not shown) as an ascending/descending means for ascending/descending the recording heads 100. By this, the plurality of recording heads 100 are moved to the predetermined height in the print position, so that it becomes possible to obtain the above-described position penetration amount.

### Suction box

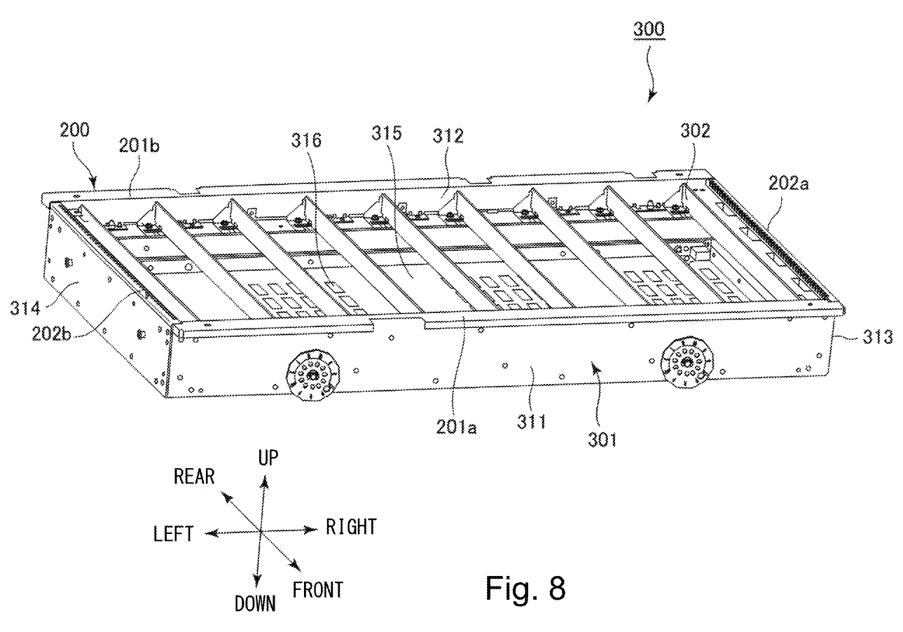

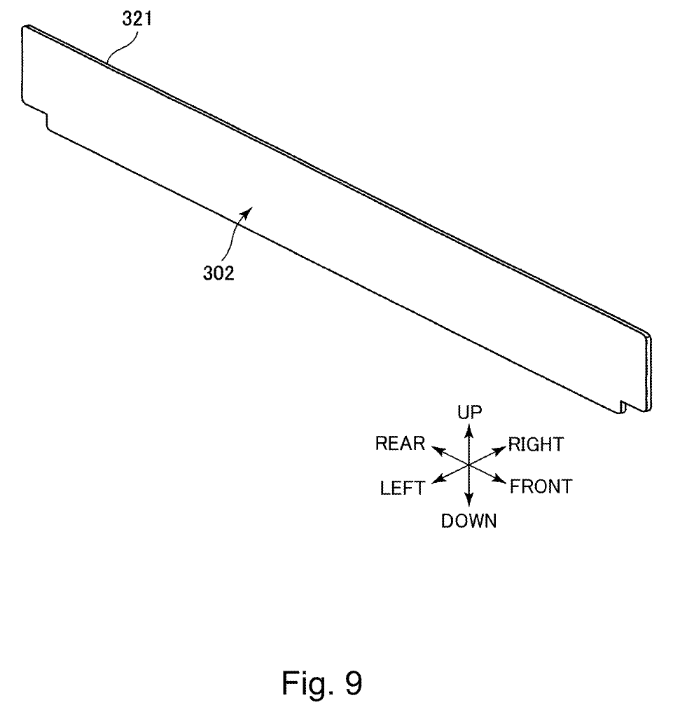

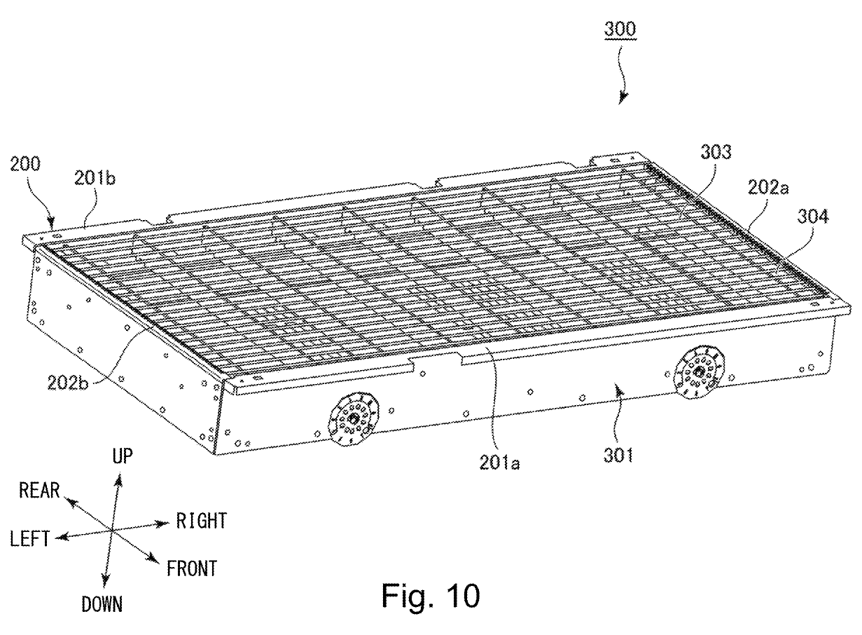

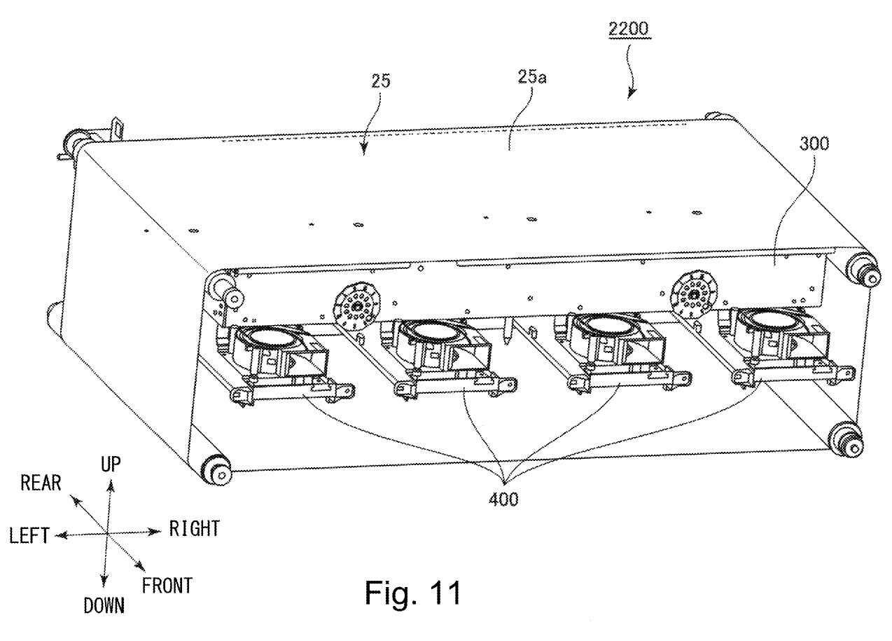

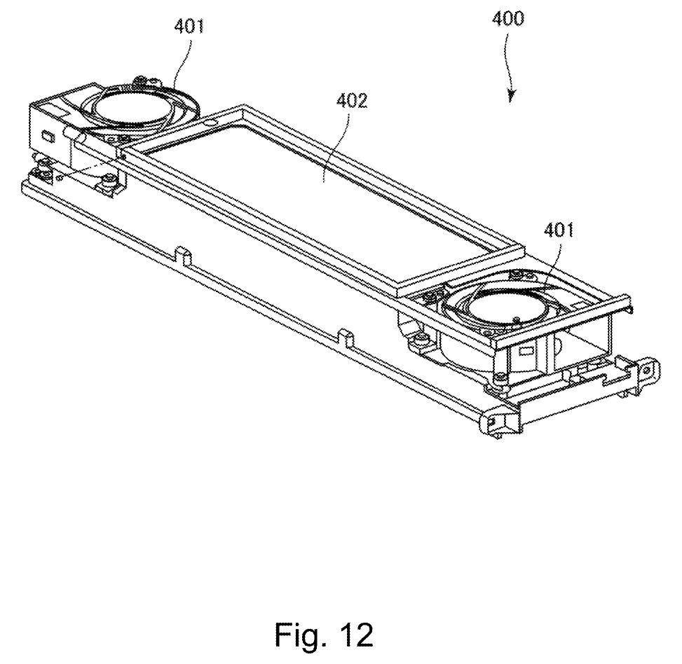

The suction box (vacuum box, platen unit) 300 in the ink jet recording apparatus 1 of this embodiment will be further described. FIG. 8 is a perspective view showing a constitution (unit frame 301, sealing member 200, or the like) of a part of the suction box in this embodiment. FIG. 9 is a perspective view showing a platen supporting member 302 described later constituting the suction box 300 in this embodiment. FIG. 10 is a perspective view of the suction box 300 in this embodiment. FIG. 11 is a perspective view of the print belt unit 2200 in which the suction box 300 is provided. FIG. 12 is a perspective view of the suction device (fan box) 400 provided in the print belt unit 2200.

As shown in FIG. 8, the suction box 300 has a predetermined length with respect to each of the longitudinal direction along the left-right direction and the widthwise direction along the frame-rear direction and a height with respect to the up-down direction, and is formed in a box shape as a whole. That is, the suction box 300 includes a front wall portion 311 and a rear wall portion 312 which extend in the left-right direction, and a right wall portion 313 and a left wall portion 314 which extend in the front-rear direction, and a bottom wall portion 315. The front wall portion 311, the rear wall portion 312, the right wall portion 313, the left wall portion 314, and the bottom wall portion 315 are connected with each other, and constitute the unit frame 301 as a holding member.

Further, the suction box 300 includes a plurality of platen supporting portions 302 which are arranged and disposed with intervals between the right wall portion 313 and the left wall portion 314 so as to connect the front wall portion 311 and the rear wall portion 312 and which extend in the front-rear direction. In this embodiment, in the suction box 300, nine platen supporting members 302 are equidistantly arranged and disposed in the left-right direction. From a viewpoint that flatness of the conveying surface 25a of the print belt 25 opposing the recording heads 100 in sufficiently enhanced, the platen supporting members 302 may preferably be provided in the following manner. That is, it is preferable that at least one of the platen supporting members 302 is provided in each of positions opposing the most upstream recording head 100a and the most downstream recording head 100h (specifically, nozzles thereof) with respect to the movement direction of the conveying surface 25a. As shown in FIG. 9, each of the platen supporting members 302 is disposed so that the longitudinal direction thereof is substantially parallel to the front-rear direction, and is constituted by a plate-like member (platen supporting plate) disposed so that the widthwise direction thereof is substantially parallel to the up-down direction. Incidentally, each platen supporting member 302 may only be required to be disposed along a direction crossing the movement direction of the conveying surface 25a of the print belt 25, and may also be disposed with an angle (inclined) with respect to a direction substantially perpendicular to the movement direction of the conveying surface 25a of the print belt 25. In this embodiment, each of the front wall portion 311, the rear wall portion 312, the right wall portion 313, the left wall portion 314, the bottom wall portion 315, and each platen supporting portion 302 is constituted by a plate-like member (metal plate) formed of a metal material (such as stainless steel (SUS)). Further, connecting portions between the front wall portion 311, the rear wall portion 312, the right wall portion 313, the left wall portion 314, the bottom wall portion 315, and each platen supporting member 302 are fixed by an arbitrary fixing means such as fastening or welding (a combination of a plurality of these means may also be employed).

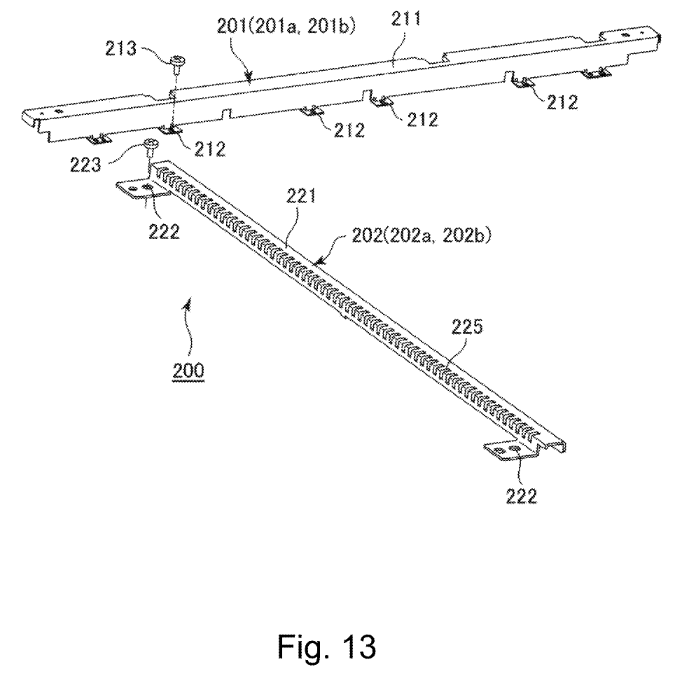

Further, as shown in FIG. 10, in the suction box 300, a plurality of platen members 303 for slidably supporting the print belt 25 are provided so as to form an upper-side surface (upper surface). The pluralities of platen members 303 are arranged and disposed with intervals therebetween (in this embodiment, substantially equidistantly) so that each platen member 303 extends substantially parallel to the left-right direction (movement direction of the conveying surface 25a) over a substantially entire region between the right wall portion 313 and the left wall portion 314. Incidentally, each platen member 303 may only be required to be disposed along the movement direction of the conveying surface 25a of the print belt 25 and may also be disposed with an angle of, for example, about ±30° (inclined) with respect to the movement direction of the conveying surface 25a of the print belt 25. In this embodiment, each platen member 303 is constituted by a wire material (metal wire), circular in cross section substantially perpendicular to an axial direction (longitudinal direction), formed of a metal material (such as stainless steel (SUS)). The interval between adjacent platen members 303 and 303 constitutes each of a plurality of upper openings (suction openings) 304 of the suction box 300. In this embodiment, opposite end portions of each platen member 303 with respect to the left-right direction are disposed in positioning portions 225 (FIG. 13) of a right sealing member 202a and a left sealing member 202b, respectively, described later, which are mounted to the right wall portion 313 and the left wall portion 314, respectively. By this, positions of each platen member 303 with respect to the front-rear direction and the left-left direction are determined. The platen members 303 are mounted on an upper end surface 321 (FIG. 9) of each of the platen supporting members 302, and when the print belt 25 is sucked by the suction device 400, the platen members 303 are supported by the platen supporting members 302, so that positions of the platen members 303 with respect to the up-down direction are determined. Thus, in this embodiment, each of the platen members 303 is constituted by the wire material extended along the movement direction of the conveying surface 25a of the print belt 25.

Further, as shown in FIG. 8, the bottom wall portion 315 of the unit frame 301 is provided with a lower opening (discharge opening) 316 which is an opening (through hole). In this embodiment, the bottom wall portion 315 is provided with a plurality lower opening 316. Incidentally, a substantially whole lower portion (bottom) of the suction box 300 may be the lower openings.

Further, to the lower opening 316 of the suction box 300, each of the suction devices 400 as a suction means are connected. As shown in FIG. 11, in this embodiment, each suction device 400 is disposed below the lower openings 316 of the suction box 300 on the inner peripheral surface side of the print belt 25. As shown in FIG. 12, each suction device 400 is constituted by including a suction fan 401 operating so as to suck the air from an inside of the suction box 300 through the lower openings 316. During recording processing (during image formation), the air is sucked by the suction devices 400 through the lower openings 316, so that the inside of the suction box 300 is kept at negative pressure. By this, the print belt 25 positioned on the plurality of platen members 303 of the suction box 300 is attracted to the platen members 303 (a sliding surface formed by the plurality of platen members 303) by being sucked through the upper openings 304 (intervals between the platen members 303). Further, the print belt 25 is provided with many suction holes (through holes) 25b (see schematic enlarged plan view in FIG. 2) each of, for example, about 0.3 mm in diameter over a full circumference thereof. By this, the sheet S conveyed by the print belt 25 is attracted to the conveying surface 25a of the print belt 25 by being sucked through these suction holes 25b. Each suction device 400 is constituted so as to discharge the air to an outside of the print belt unit 2200 and further to an outside of the casing 2500 of the print module 2000 through a duct (not shown), for example. Incidentally, an attraction (suction) force generating source of each suction device 400 is not limited to the fan, but may also be a vacuum pump, for example.

Thus, the suction devices 400 suck the air through a space enclosed by the unit frame 301 and the platen members 303, and thus urge the print belt 25 toward the platen members 303 and, in addition, urge the sheet S toward the print belt 25. Incidentally, in this embodiment, the suction box 300 is supported by a belt unit frame constituting the print belt unit 2200.

Here, as shown in FIG. 2, the sheet S is conveyed in the conveying direction (direction from the right side toward the left side) shown by an arrow A in FIG. 2 by the print belt 25 of the print belt unit 2200. Further, each suction device 400 sucks (urges) the print belt 25 toward a suction direction shown by an arrow B in FIG. 2. For that reason, during the recording processing, the print belt 25 perforated with minute holes over the full circumference thereof is sucked toward the suction direction B.

Further, the print belt 25 contacts the platen members 303 of the suction box 300 and rotates while sliding with the platen members 303. By this, the conveying surface 25a of the print belt 25 follows the sliding surface formed by the plurality of platen members 303 of the suction box 300, and therefore, high flatness of the conveying surface 25a can be obtained. High accuracy of the flatness of the sliding surface formed by the plurality of the platen members 303 of the suction box 300 leads to that accuracy of a distance (print gap) between the recording heads 100 and the sheet S is maintained (set to a target value). Further, the sheet S is also sucked (urged) toward the suction direction B by the suction devices 400. For that reason, even when floating, curling, or the like occurs, the sheet S is sucked by the conveying surface 25a of the print belt 25, and follows the flatness of the conveying surface 25a, i.e., flatness of the sliding surface formed by the plurality of platen members 303. As a result, the sheet S of which flat surface state is maintained with high accuracy can be subjected to the recording processing, so that it becomes possible to form an image with high accuracy and a high quality.

In this embodiment, the upper end surface (edge) 321 of each platen supporting member (supporting metal plate) 302 is formed with accuracy of 0.03 mm or more and 0.06 mm or less in terms of straightness (JIS B 0621). In this embodiment, in each platen supporting member 302, only the upper end surface 321 is subjected to polishing processing, so that the above-described accuracy is realized. Further, for example, an operator mounts the nine platen supporting member 302 to the unit frame 301 while adjusting a height (adjusted residual: about 0.05 mm) and thus assembles these members. By this, not only accuracy of the platen supporting member 302 alone, but also high surface accuracy (for example, flatness (JIS B 0621): 0.2 mm or less) between the upper end surfaces 321 of the nine platen supporting member 302 can be realized. Thus, in this embodiment, the unit frame 301 (the front wall portion 311, the rear wall portion 312) and the platen supporting members 302 are constituted so that positions of the platen supporting member 302 relative to the unit frame 301 with respect to the up-down direction are adjustable.

Further, on the upper end surfaces 321 of the nine platen supporting members 9 mounted to the unit frame 301 while being adjusted in height, the platen members (metal wire materials) 303 are mounted. Then, the print belt 25 is sucked by the suction device 400 positioned on a side below the unit frame 301, so that the platen members 303 follow flatness of the upper end surfaces 321 of the platen supporting members 302 while being deformed. By this, as an element relating to flatness (flatness of the printing surface) of the conveying surface 25a of the print belt 25, straightness of the platen member 303 alone can be disregarded, so that each platen member 303 may only be required to consider only wired diameter tolerance (in this embodiment, 0.02 mm). From a viewpoint of sufficiently enhancing the flatness of the conveying surface 25a of the print belt 25, the wire diameter tolerance of the wire material constituting each platen member 303 may preferably be 0.03 mm or less (may also be 0 mm).

In this embodiment, a wire diameter of a wire material constituting the platen member 303 is about 3.2 mm, and a pitch ( a center-to-center distance between adjacent platen members 303 in the front-rear direction) of the plurality of platen members 303 is about 6.0 mm. Further, in this embodiment, a length of a portion of each platen member 303 contactable to the print belt 25 in the movement direction of the conveying surface 25a of the print belt 25 is about 700 mm. The above-described wire diameter and the above-described pitch can be appropriately set in view of the upper openings 304 are sufficiently provided and that sufficient flatness of the conveying surface 25a of the print belt 25 can be realized when the print belt 25 is sucked by the suction device 400. Although not limited thereto, for example, the wire diameter constituting the platen member 303 may suitably be about 2.0 mm or more and about 5.0 mm or less. Further, although not limited thereto, for example, the pitch of the plurality of platen members 303 may suitably be about 3.0 mm or more and about 10 mm or less. The number of the platen members 303 may be appropriately set so that the platen members 303 are contactable to the print belt 25 at least in a range including an entire are of a region in which the sheet S is capable of being carried with respect to the widthwise direction (front-rear direction) of the print belt 25. Incidentally, the platen member 303 may include a coating formed of a resin material on a base material constituted by a wire material.

By the constitution of the suction box 300 as described above, in expensive and wide-range flatness can be efficiently achieved with high accuracy.

### Sealing member

As described above, the upper surface of the suction box 300 is formed by the platen members 300 and has a function of forming the conveying surface (image forming surface, printing surface) 25a of the print belt 25 opposing the recording heads 100 in a position immediately below the recording heads 100 (FIG. 2). Further, immediately below the suction box 300, the suction devices 400 are provided. In this embodiment, each suction device 400 is constituted by including at least one fan 401 (FIG. 12), and is formed in a box shape. A contact portion 402 (FIG. 12) provided at an upper-side surface of the suction device 400 contacts a lower surface of the suction box 300. Further, in this embodiment, the print belt unit 2200 is constituted so that a space inside the suction box 300 is maintained at a substantially uniform negative pressure of , for example, 500 Pa by suction with the suction devices 400.

The suction box 300 is formed in the box shape by fine surfaces consisting of the front wall portion 311, the rear wall portion 312, the right wall portion 313, the left wall portion 314, and the bottom wall portion 315 and by one surface of the print belt 25 contacting an upper surface of the suction box 300 (FIGS. 8 and 11). The inside of the suction box 300 is put in the substantially uniform negative pressure state, so that irrespective of presence/absence of the sheet S, a load exerted on the inner peripheral surface of the print belt 25 by the suction with the suction devices 400 can be made substantially constant. For that reason, from the viewpoint of control of the print belt 25, it is desired that the inside of the suction box 300 is put in the substantially uniform negative state.

Here, for example, in order to realize downsizing of the fan 401 of the suction device 400, it is effective to enhance a sealing property of the suction box 300 so that the inside of the suction box 300 can be efficiently put in the substantially uniform negative pressure state. As one of means for enhancing the sealing property of the suction box 300, it is effective that a sealing member constituting a planar edge is provided on four sides enclosing a region, of the upper surface of the suction box 300, where the platen members 303 are provided.

In this embodiment, as shown in FIGS. 8 and 10, a sealing member 200 is provided on the four sides enclosing the region, of the upper surface of the suction box 300 contacting the inner peripheral surface of the print belt 25, where the plurality of platen members 303 are provided. In this embodiment, the suction box 300 is provided with, as the sealing member 200, a front sealing member (first sealing member) 201a and a rear sealing member (second sealing member) 201b which are provided to the front wall portion 311 and the rear wall portion 312, respectively, and a right sealing member (third sealing member) 202a and a left sealing member (fourth sealing member) 202b which are provided to the right wall portion 313 and the left wall portion 314, respectively. As a result, as shown in FIG. 11, fluttering of the print belt 25 with respect to the vertical direction is suppressed by upper surfaces of the front sealing member 201a, the rear sealing member 201b, the right sealing member 202a, and the left sealing member 202b, so that the print belt 25 can be stabilized. Further, by sealing the suction box 300 with the inner peripheral surface of the print belt 25, the upper surfaces of the front sealing member 201a, the rear sealing member 201b, the right sealing member 202a, and the left sealing member 202b, the sealing property of the suction box 300 can be enhanced.

In this embodiment, the front sealing member 201a and the rear sealing member 201b substantially have the same constitution. Accordingly, the front sealing member 201a and the rear sealing member 201b are collectively referred to as a "front/rear sealing member 201" in some instances. Further, in this embodiment, the right sealing member 202a and the left sealing member 202b substantially have the same constitution. Accordingly, the right sealing member 202a and the left sealing member 202b are collectively referred to as a "upstream/downstream sealing member 202" in some instances. In this embodiment, the "sealing member 200" is constituted by the front/rear sealing member 201 and the upstream/downstream sealing member 202.

Thus, in this embodiment, the unit frame 301 is provided with, as the sealing member 200, the first sealing member, the second sealing member, the third sealing member, and the fourth sealing member. The first sealing member (front sealing member) 201a includes a contact surface 211 disposed, along the movement direction of the print belt 25 at the conveying surface 25a, outside one end portion of a region in which the platen members 303 with respect to a direction substantially perpendicular to the above-described movement direction are provided. The second sealing member (rear sealing member) 201b includes a contact surface 211 disposed, along the above-described movement direction, outside the other end portion of the above-described region with respect to the direction substantially perpendicular to the above-described movement direction. The third sealing member (right sealing member) 202a includes a contact surface 221 disposed, along the direction substantially perpendicular to the above-described movement direction, outside one end portion of the region with respect to the above-described movement direction. The fourth sealing member (left sealing member) 202b includes a contact surface 221 disposed, along the direction substantially perpendicular to the above-described movement direction, outside the other end portion of the region with respect to the above-described movement direction.

FIG. 13 is a perspective view showing the front/rear sealing member 201 and the upstream/downstream sealing member 202. The front/rear sealing member 201 extends in the left-right direction and includes a planar contact surface (sliding surface) 211 contactable to the inner peripheral surface of the print belt 25. The contact surface 211 of the front/rear sealing member 201 is constituted by the upper-side surface (upper surface) directed toward the print belt 25 side of the front/rear sealing member 201. The contact surface 211 of the front/rear sealing member 201 is a flat surface. Further, the front/rear sealing member 201 includes a fixing portion 212 or the like for fixing the front/rear sealing member 201 to the front wall portion 311 or the rear wall portion 312 as described later. The upstream/downstream sealing member 202 extends in the front-rear direction and includes a planar contact surface (sliding surface) 221 contactable to the inner peripheral surface of the print belt 25. The contact surface 221 of the upstream/downstream sealing member 202 is constituted by the upper-side surface (upper surface) directed toward the print belt 25 side of the upstream/downstream sealing member 202. The contact surface 221 of the upstream/downstream sealing member 202 is a flat surface. Further, the upstream/downstream sealing member 202 includes, as described later, a fixing portion 222 for fixing the upstream/downstream sealing member 202 to the right wall poerion 313 or the left wall portion 314, a plurality of positioning portions 225 for positioning the platen members 303 with respect to the front-rear direction and the left-right direction. In each of the positioning portions 225 of the upstream/downstream sealing member 202, a portion-to-be-positioned provided in an end portion on a right side or a left side of the associated platen member 303.

Incidentally, when the sealing member 200 is provided in at least a part around the region where the platen members 303 are provided, a corresponding effect can be obtained. However, in order to more effectively enhance the sealing property of the suction box 300, the sealing member 200 may preferably be provided substantially entirely around the region where the platen members 303 are provided, typically provided on all of the four sides enclosing the region where the platen members 303 are provided.

The sealing member 200 slides with the print belt 25. For that reason, when the contact surfaces 211 and 221 (herein, simply referred also to as "upper surface(s)" of the sealing member 200 or the inner peripheral surface of the print belt 25 is contaminated by deposition of a contaminant such as ink mist, friction coefficient between these members increases, so that a sliding resistance increases. By this, a torque of a driving motor for driving the print belt 25 becomes insufficient and there is a possibility that inconveniences such that stable drive of the print belt 25 becomes difficult occurs, and therefore, it is desired that the increase in the above-described sliding resistance is suppressed or that the above-described sliding resistance is lowered.

Here, when the upper surface of the sealing member 200 and the inner peripheral surface of the print belt 25, on which the contaminant such as the ink mist is deposited is cleaned, the above-described sliding resistance can be lowered. However, for cleaning the sealing member 200, there is a need to remove the print belt unit 2200 and many parts therearound, so that it takes labor and time for maintenance.

Therefore, it is effective that the contamination is collected on the inner peripheral surface of the print belt 25 which can be cleaned relatively easily. For that purpose, it is effective that surface free energy of the upper surface of the sealing member 200 is made smaller than surface free energy of the inner peripheral surface of the print belt 25. Incidentally, the surface free energy of the member (material) can be evaluated by using, for example, known method in which a contact angle of the member (material) is measured by using a liquid of which physical property is known and then the surface free energy of the member (material) is calculated by calculation from the physical property of the liquid and the contact angle of the liquid. Or, as the surface free energy of the member (material), a nominal value relating to the member (material) may also be utilized.

The case where the print belt 25 (at least the inner peripheral surface thereof is constituted by resin, for example, PET and where the sealing member 200 (at least the upper surface thereof) is constituted by metal, for example stainless steel will be considered. In this case, a relationship between the surface free energy of the print belt 25 and the surface free energy of the sealing member 200 satisfies: "(upper surface of sealing member 200) > (inner peripheral surface of print belt 25)". For this reason, the contamination is not collected on the print belt 25.

On the other hand, by subjecting the upper surface of the sealing member 200 to surface treatment, for example, fluorine coating (fluorine-containing resin coating), the above-described relationship can be made to satisfy: "(inner peripheral surface of print belt 25) > (upper surface of sealing member 200)". By this, the contamination is not readily deposited on the sealing member 200 and is collected on the print belt 25. For that reason, as described above, by cleaning the inner peripheral surface of the print belt 25 which is cleaned relatively easily, it becomes possible to suppress the increase in sliding resistance between the sealing member 200 and the print belt 25. Incidentally, cleaning of the inner peripheral surface of the print belt 25 can be performed, for example, by inserting a cleaning member from an outside of an inner peripheral surface side of the print belt 25 and then by rubbing the inner peripheral surface of the print belt 25 with this cleaning member.

In this embodiment, the print belt 25 is constituted by the PET. Further, in this embodiment, the sealing member 200 is formed by the plate-like member (metal plate) formed of the metal material (stainless steel such as SUS). Further, in this embodiment, the sealing member 200 includes a coating formed of a resin material on a base material constituted by the metal plate. As a material of the resin coating, fluorine-containing resin such as PTFE (polytetrafluoroethylene) or PFA (perfluoroalkoxy alkane) may suitably be used. In this embodiment, at least the upper surface (contact surface 211, 221) of the sealing member 200 is subjected to the fluorine coating. Incidentally, a substantially entire region of the surface of the sealing member 200 may be subjected to the surface treatment (fluorine coating or the like). A thickness of the coating can be made typically about several μm to several tens of μm (for example, 3 μm or more and 50 μm or less).

Incidentally, in this embodiment, the platen member 303 includes a coating formed by a resin material similar to the above-described resin material on a base material constituted by a wire material mode of metal. For that reason, in this embodiment, even in the relationship between the platen member 303 and the print belt 25, the contaminant is not readily deposited and is collected on the print belt 25.

However, by sliding the print belt 25 and the sealing member 200 with each other, a portion where the sealing member 200 is subjected to the surface treatment (fluorine coating) is abraded. By this abrasion, when the portion where the sealing member 200 is subjected to the surface treatment (fluorine coating) is lost, the relationship of the surface free energy becomes "(upper surface of sealing member 200) > (inner peripheral surface of print belt 25)" reverse to the above-described relationship.

Thus, when the portion where the sealing member 200 is subjected to the surface treatment (fluorine coating) is abraded, a magnitude relationship of the surface free energy between the sealing member 200 and the print belt 25 is changed, so that the sealing member 200 is liable to be contaminated. As described above, the cleaning of the sealing member 200 requires labor and time compared with cleaning of the inner peripheral surface of the print belt 25. Further, as described further in an embodiment 2 later, when the sealing member 2 is abraded, there is a possibility that inconveniences such as a lowering in sealing property of the suction box 300 occur. For that reason, before the portion where the sealing member 200 is subjected to the surface treatment (fluorine coating) is lost by abrasion, it is desired that the sealing member 200 is exchanged.

Therefore, in this embodiment, each of the front sealing member 201a, the rear sealing member 201b, the right sealing member 202a, and the left sealing member 202b is constituted so as to be capable of being exchanged by being made detachably mountable to the unit frame 301.

As shown in FIG. 13, in this embodiment, the front/rear sealing member 201 is fixed to the unit frame 301 in a fixing portion 212 by a screw 213 which is a fastening member (fixing tool) as a fixing means. Similarly, in this embodiment, the upstream/downstream sealing member 202 is fixed to the unit frame 301 in a fixing portion 222 by a screw 223 which is a fastening member (fixing tool) as a fixing means. For that reason, by disconnecting the screws 213 and 223 from the unit frame 301, it is possible to demount the front/rear sealing member 201 and the upstream/downstream sealing member 202 from the unit frame 301. In this embodiment, the front/rear sealing member 201 and the upstream/downstream sealing member 202 can be demounted from the unit frame 301 only by substantially disconnecting the screws, so that there is no need to disassemble the suction box 300 and thus exchange of each of the front/rear sealing member 201 and the upstream/downstream sealing member 202 is easy. Incidentally, the fixing means of the sealing member 200 is not limited to the fastening member, but it is possible to utilize a detachably mountable arbitrary means such as press-fit engagement, snap-fit engagement (resilient engagement), or the like.

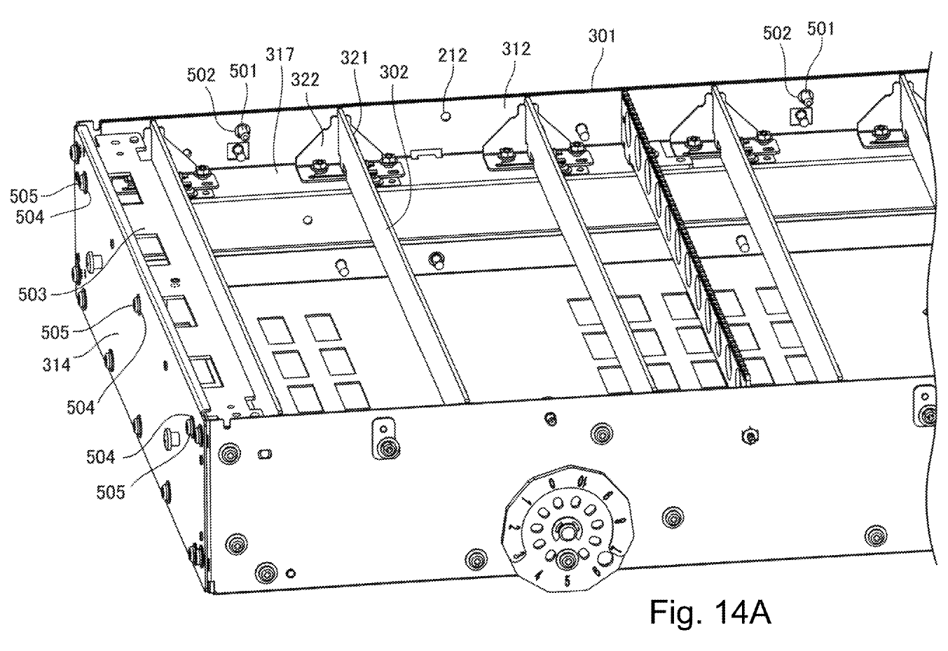

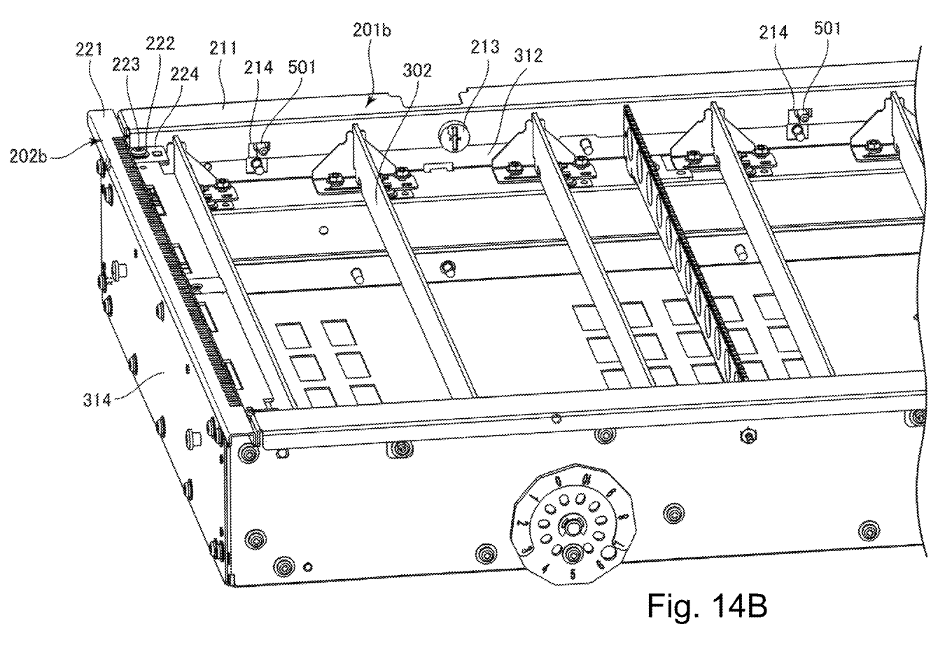

Incidentally, the detachably mountable sealing member 200 is desired so as to be mountable to the unit frame 301 with positional accuracy from viewpoints of the sealing property (suction efficiency) of the suction box 300, the flatness of the conveying surface 25a of the print belt 25, and the like. With reference to FIG. 14A and FIG. 14B, an example of a mounting (positioning) constitution of the sealing member 200 in accordance with this embodiment will be described. FIG. 14A is a perspective view showing a part of the unit frame 301 from which the sealing member 200 is demounted. FIG. 14B is a perspective view showing a part of the unit frame 301 to which the sealing member 200 is mounted.

As described above, in this embodiment, high flatness of the conveying surface 25a of the print belt 25 is obtained by adjusting and assembling the platen supporting members 302, formed with processing accuracy, with positional accuracy and then by mounting the platen members 303 thereon. Therefore, in this embodiment, the unit frame 301 is provided with a sealing member positioning portion adjusted in position (height) so as to satisfy a predetermined relationship with a position (height) of the upper end surface 321 of each of the adjusted and assembled platen supporting members 302. Then, the sealing member 200 is contacted to this sealing member positioning portion, and is fixed to the unit frame 301 in a state in which the position (height) thereof is determined.

Incidentally, in this embodiment, mounting constitutions of the front sealing member 201a and the rear sealing member 201b are substantially the same, and mounting constitutions of the right sealing member 202a and the left sealing member 202b are substantially the same. Here, by taking the rear sealing member 201b and the left sealing member 202b as an example, an example of the mounting constitution thereof will be described.

As shown in part FIG. 14A, each platen supporting member 302 is mounted to a mounting portion 317, provided to the unit frame 301, by a mounting member 322. During the mounting of this platen supporting member 302, between the mounting member 322 and the mounting portion 317, a shim which is an adjusting member is appropriately interposed or the like, so that the position (height) of each platen supporting member 302 is adjusted.

Further, a positioning projection 501 as the sealing member positioning portion is mounted to the rear wall portion 312 by being adjusted in position (height) so as to satisfy a predetermined relationship with a position (height) of the upper end surfaces 321 of the above-described adjusted and assembled platen supporting members 302. The positioning projection 501 is provided in a plurality of positions along the left-right direction so as to project toward an inside of the unit frame 301 along the front-rear direction. The positioning projection 501 is fixed in a desired position of an elongated-shaped positioning projection fixing hole 502, with respect to the up-down direction, having a degree of freedom with respect to the up-down direction. The positioning projection 501 may be constituted by a screw or the like.

Further, a positioning table 503 as the sealing member positioning portion is mounted to the left wall portion 314 by being adjusted in position (height) so as to satisfy a predetermined relationship with the position (height) of the upper end surfaces 321 of the above-described adjusted and assembled platen supporting members 302. The positioning table 503 is extended along the front-rear direction so as to project toward an inside of the unit frame 301 along the left-right direction.

The positioning table 503 is fixed by a screw 505 in a desired position with respect to the up-down direction through an extended-shaped positioning table fixing hole 504 having a degree of freedom with respect to the up-down direction. An upper surface of the positioning table 503 is formed with sufficiently high surface accuracy.

Further, as shown in FIG. 14B, to the above-mounted positioning projection 501, an edge (end surface) of positioning groove 214 as a portion-to-be-positioned provided to the rear sealing member 201b is contacted, so that a position (height) of the rear sealing member 201b is determined. In this state, the rear sealing member 201b is fixed to the rear wall portion 312 by the screw 213 through the fixing portion (fixing hole) 212 provided in the rear sealing member 201b.

Further, to the above-mounted positioning projection 503, positioning tab 224 as a portion-to-be-positioned provided to the left sealing member 202b is contacted, so that a position (height) of the left sealing member 202b is determined. In this state, the left sealing member 202b is fixed to the positioning table 503 by the screw 223 through the fixing portion (fixing hole) 222 provided in the left sealing member 202b (positioning tab 224). By this, the left sealing member 202b is fixed to the left wall portion 314 through the positioning table 503.

Thus, the holding member (unit frame) 301 includes the platen supporting members 302 for supporting the platen members 303 and the positioning portions (the positioning projections 501, the positioning table 503) which are positioning portions for determining positions with respect to the direction substantially perpendicular to the conveying surface 25a of the sealing member 200 and of which positions relative to the platen supporting members 302 with respect to the direction substantially perpendicular to the conveying surface 25a are determined. In this case, the sealing member 200 is contacted to the positioning portions 501 and 503 and is mounted to the holding member 301.

Here, a predetermined relationship of positions (heights) of the sealing member positioning portions (the positioning projections 501, the positioning table 503) with positions (heights) of the upper end surfaces 321 of the platen supporting members 302 is set in the following manner, for example. That is, from a viewpoint of the sealing property (suction efficiency) of the suction box 300 or the like, the predetermined relationship may preferably be set so that the upper surfaces (the contact surfaces 211 and 221) of the sealing member 200 and the sliding surface of the print belt 25 formed by the plurality of platen members 303 become substantially flush with each other (become substantially the same position (height)). Further, as regards the upstream/downstream sealing member 202, setting is made so that a position of the upper surface thereof is not below a position of the sliding surface of the platen member 303. This is because damage of the inner peripheral surface of the print belt 25 by the edges of the end portions of the platen member 303 with respect to the left-right direction is suppressed. That is, the upper surface (contact surface 221) of the sealing member 200 disposed on at least one of the upstream side and the downstream side of the platen member 303 with respect to the movement direction of the print belt 25 at the conveying surface 25a may preferably be positioned on a print belt side with respect to the direction substantially perpendicular to the conveying surface 25a than the platen member 303 supported by the platen supporting member 302 is.

As regards the upstream/downstream sealing member 202, a position of an upper surface thereof may be shifted by, for example, about 0.5 mm or less, preferably about 0.1 mm or less, further preferably about 0.05 mm or less when the upper surface position is above the position of the sliding surface by the platen member 303. Further, as regards the front/rear sealing member 201, a position of an upper surface thereof may be vertically shifted by, for example, about 0.5 mm or less, preferably about 0.1 mm or less, further preferably about 0.05 mm or less.

Incidentally, in the case where as the platen member, for example, a flat plate provided with an opening or the like member is used, for the reason similar to the above-described reason, as regards not only the upstream/downstream sealing member 202 but also the front/rear sealing member 201, it is preferable in some instances that at least a position of an upper surface thereof is not below the position of the above-described sliding surface. In that case, the position of the upper surface of the front/rear sealing member 201 may be shifted from the position of the sliding surface in a range similar to a range relating to the above-described upstream/downstream sealing member 202.

Thus, in this embodiment, the position (height) of the sealing member 200 is determined by butting the sealing member 200 against the sealing member positioning portion of which position (height) is determined relative to the platen supporting member 302 for determining the position (height) of the platen member and which is not removed from the unit frame 301. By this, during exchange of the sealing member 200 the sealing member 200 can be mounted to the unit frame 301 without performing a complicated operation for determining the position (height) of the sealing member 200.

An exchange timing (exchange interval, lifetime) of the sealing member 200 can be set in advance on the basis of a period until the portion subjected to the surface treatment (fluorine coating) is abraded and lost, or the like. Further, this exchange timing can be set by an arbitrary index such as a time or a driving amount (the number of sheets S on which images are formed, the number of rotations of the print belt 25, a rotation time, and the like) of the apparatus, and the like.

Incidentally, in this embodiment, the platen member 303 is also capable of being exchanged by being demounted from and mounted to the unit frame 301. The platen member 303 is set to the unit frame 301 by being mounted on the platen supporting member 302 and, in addition, by being disposed in the positioning portion 225 of the upstream/downstream sealing member 202 at each of opposite end portions thereof as described above. For that reason, the platen member 303 can be exchanged by being easily demounted from and mounted to the unit frame 301.

As described above, according to this embodiment, the sealing member 200 for enhancing the sealing property of the suction box 300 is made detachably mountable to the unit frame 301, so that it becomes possible to maintain a good state of the sealing member 200 relatively easily. That is, according to this embodiment, improvement in maintenance property of the sealing member 200 provided to the unit frame 301 which is the holding member of the platen members 303 can be realized.

### Embodiment 2

Next, another embodiment of the present disclosure will be described. The basic structure and operation of an image forming apparatus of this embodiment are the same as those of the image forming apparatus of the embodiment 1. Therefore, in the image forming apparatus of this embodiment, elements having the same or corresponding functions or structures as those of the image forming apparatus of the embodiment 1 are denoted by the same reference numerals or symbols as those of the image forming apparatus of the embodiment 1, and detailed description thereof will be omitted.

In this embodiment, materials constituting the print belt 25 and the sealing member 200 are different from those in the embodiment 1.

The case where the print belt 25 (at least the inner peripheral surface thereof) is constituted by metal, for example, stainless steel and the sealing member 200 (almost entirety thereof) is constituted by resin, for example, fluorine-containing resin will be considered. In this case, the relationship of the surface free energy satisfied "(inner peripheral surface of print belt 25) > (upper surface of sealing member 200)". For that reason, the contaminant is collected on the print belt 25.

However, the print belt 25 and the sealing member 200 slide with each other, so that the sealing member 200 constituted by the fluorine-containing resin is abraded. When the sealing member 200 is abraded, there is a possibility that inconveniences such as a lowering in sealing property of the suction box 300 and a lowering in stability of the print belt 25 with respect to the up-down direction occur. For that reason, it is desired that the sealing member 200 is exchanged before the sealing member 200 is abraded by exceeding a tolerable amount.

Therefore, it is effective that the sealing member 200 is constituted so as to be capable of being exchanged by being demounted from and mounted to the unit frame 301 similarly as in the embodiment 1 also in the case where the sealing member 200 is constituted by the resin (fluorine-containing resin or the like).

Also, in this case, similarly as described in the embodiment 1, each of the front sealing member 201a, the rear sealing member 201b, the right sealing member 202a, and the left sealing member 202b can be constituted so as to be capable of being exchanged by being demounted from and mounted to the unit frame 301. By this, an effect similar to the effect of the embodiment 1.

### Embodiment 3

Next, another embodiment of the present disclosure will be described. The basic structure and operation of an image forming apparatus of this embodiment are the same as those of the image forming apparatus of the embodiment 1. Therefore, in the image forming apparatus of this embodiment, elements having the same or corresponding functions or structures as those of the image forming apparatus of the embodiment 1 are denoted by the same reference numerals or symbols as those of the image forming apparatus of the embodiment 1, and detailed description thereof will be omitted.

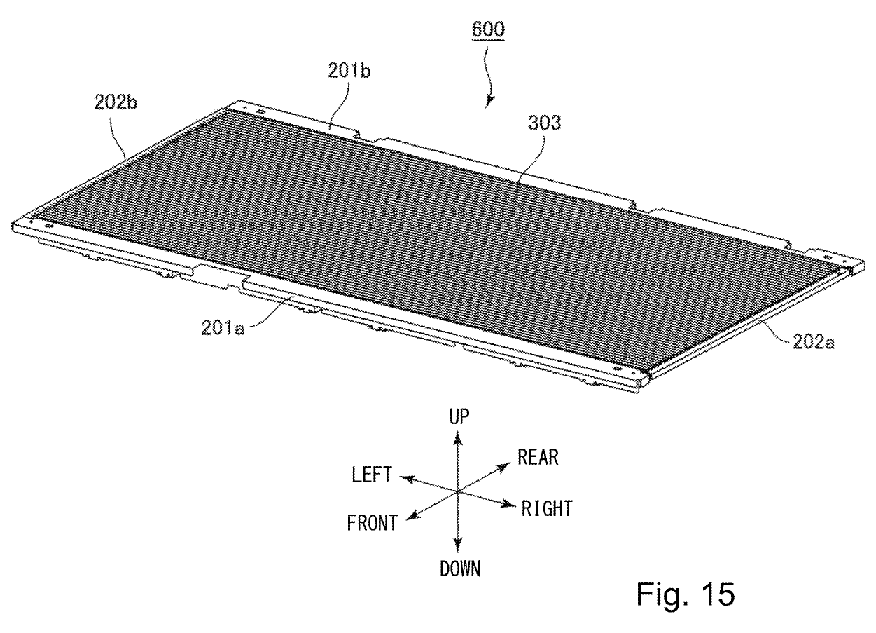

In the embodiments 1 and 2, each of the front sealing member 201a, the rear sealing member 201b, the right sealing member 202a, and the left sealing member 202b is independently made detachably mountable to the unit frame 301, but the present disclosure is not limited thereto. For example, as shown in FIG. 15, it is possible to constitute an exchange unit 600 prepared by assembling the platen members 303, the front sealing member 201a, the rear sealing member 201b, the right sealing member 202a, and the left sealing member 202b into a unit. Each platen member 303 can be constituted by subjecting a wire material made of metal to surface treatment (fluorine coating) similarly as in the embodiment 1. Further, the sealing member 200 can be constituted similarly as in the embodiment 1 by being formed with a plate-like member made of metal and then by subjecting the plate-like member to surface treatment (fluorine coating). Incidentally, each platen member 303 may only be required to be disposed so as to be extended between the upstream/downstream sealing members 202 (202a, 202b) and is not required to be fixed. Further, the front sealing member 201a, the rear sealing member 201b, the right sealing member 202a, and the left sealing member 202b may also be only connected to each other so as to be easily disassembled with each other.

This exchange unit 600 is prepared by collecting members each subjected to surface treatment (fluorine coating), and all the members slid with the print belt 25 in contact with the print belt 25. For that reason, when the exchange unit 600 is abraded by use thereof, the relationship of the surface free energy satisfies "(print belt 25) < (exchange unit 600)". Accordingly, the exchange unit 600 is constituted so as to be capable of being exchanged by being integrally made detachably mountable to the unit frame 301, so that the members sliding with the print belt 25 in contact with the print belt 25 can be easily exchanged integrally with each other.

Also, in this case, fixing of each of the front sealing member 201a, the rear sealing member 201b, the right sealing member 202a, and the left sealing member 202b to the unit frame 301 can be performed similarly as in the embodiment 1. Further, in the exchange unit 600, positioning of the platen members 303 by the platen supporting members 302 can also be performed similarly as in the embodiment 1.

Also, in the constitution of this embodiment, only the exchange unit 600 can be demounted from the unit frame 301, and therefore, there is no need to disassemble the suction box 300, so that the exchange of the exchange unit 600 is easy.

### Other embodiments

In the above, the present disclosure was described based on specific embodiments, but the present disclosure is not limited to the above-described embodiments.

In the above-described embodiments, the case where the exchange of the sealing member is required due to abrasion of the sealing member was described as an example, but the sealing member may also be exchanged for another reason such that the contaminant is deposited by exceeding a tolerable amount, for example.

In the above-described embodiments, each platen member was constituted by the wire material, but the platen member may also be constituted by a flat plate provided with a plurality of openings, for example.

According to the present disclosure, it is possible to realize improvement in maintenance property of the sealing member provided on the holding member for holding the platen members.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-192528, filed on October 31, 2024, which is hereby incorporated by reference herein in its entirety.

What is claimed is:

1. An image forming apparatus comprising:
a rotatable endless belt provided with a plurality of holes and configured to carry and convey a sheet;
a recording head provided opposed to the belt and configured to eject a liquid for recording to the sheet conveyed by the belt;
a platen portion configured to slidably support an inner peripheral surface of the belt in a position opposing the recording head through the belt and configured to form a conveying surface on which the sheet is conveyed;
a suction box configured to hold the platen portion and configured to suck the belt to the platen portion by negative pressure generated inside the suction box and suck the sheet onto the belt through the plurality of holes;
a negative pressure generating portion configured to generate the negative pressure in the suction box; and
an extension member which is provided detachably mountable to the suction box, which is disposed outside the platen portion with respect to a widthwise direction thereof perpendicular to a conveying direction of the belt, which is extended along a movement direction of the belt, which includes a sliding surface slidable with the inner peripheral surface of the belt, and which is configured so that an end portion of the belt closely contacts the sliding surface.

2. The image forming apparatus according to claim 1, wherein the extension member includes a base material including a portion which forms the sliding surface and of which surface is provided with a coating.

3. The image forming apparatus according to claim 2, wherein the coating is a fluorine-containing resin coating.

4. The image forming apparatus according to claim 1, wherein the extension member is constituted by a resin material.

5. The image forming apparatus according to claim 1, wherein the suction box includes a platen supporting member for supporting the platen portion and includes a positioning portion for positioning a position of the extension member with respect to a direction substantially perpendicular to the conveying surface and of which position relative to the platen supporting member with respect to the direction substantially perpendicular to the conveying surface is determined, and
wherein the extension member is mounted to the suction box by being contacted to the positioning portion.

6. The image forming apparatus according to claim 5, wherein the platen portion includes a sliding member including a sliding surface which is constituted by a wire extended along the movement direction of the belt on the conveying surface, which is provided on at least one of sides upstream of and downstream of the platen portion with respect to the movement direction, which is extended in a widthwise direction of the belt, and which is slidable with the belt, and
wherein the positioning portion is positioned relative to the platen supporting member so that the sliding surface disposed on at least one of the sides upstream of and downstream of the platen portion with respect to the movement direction is positioned on a belt side relative to the platen portion supported by the platen supporting member with respect to the direction substantially perpendicular to the conveying surface.

7. The image forming apparatus according to claim 1, wherein as the extension member, a first extension member provided along the movement direction of the belt on the conveying surface and provided with the sliding surface disposed outside one end portion of a region in which the platen portion is provided, with respect to a direction substantially perpendicular to the movement direction and a second extension member provided along the movement direction and provided with the sliding surface disposed outside the other end portion of the region with respect to the direction substantially perpendicular to the movement direction are provided.

8. The image forming apparatus according to claim 6, wherein as the sliding member, a first sliding member including the sliding surface provided along a direction substantially perpendicular to the movement direction and disposed outside one end portion of a region, in which the platen portion is provided, with respect to the movement direction and a second sliding member including the sliding surface provided along the direction substantially perpendicular to the movement direction and disposed outside the other end portion of the region with respect to the movement direction are provided.

9. The image forming apparatus according to claim 8, wherein as the extension member, a first extension member provided along the movement direction of the belt on the conveying surface and provided with the sliding surface disposed outside one end portion of a region in which the platen portion is provided, with respect to a direction substantially perpendicular to the movement direction and a second extension member provided along the movement direction and provided with the sliding surface disposed outside the other end portion of the region with respect to the direction substantially perpendicular to the movement direction are provided.

10. The image forming apparatus according to claim 9, wherein the first extension member, the second extension member, the first sliding member, the second sliding member, and the platen portion are constituted individually detachably mountable to the suction box.

11. The image forming apparatus according to claim 9, wherein the first extension member, the second extension member, the first sliding member, the second sliding member, and the platen portion are constituted integrally detachably mountable to the suction box.
